(19) United States
(12) Patent Application Publication
(10) Pub. No.: US 2026/0285232 A1
(43) Pub. Date: Sep. 24, 2026

(54) METHOD FOR REPRESENTING SURROUNDINGS OF A VEHICLE

(71) Applicant: AUDI AG, Ingolstadt (DE)

(72) Inventors: Stephan SCHWANTNER, Pollenfeld (DE); Christian GROSS, Ingolstadt (DE)

(21) Appl. No.: 19/474,676

(22) PCT Filed: Apr. 3, 2024
(86) PCT No.: PCT/EP2024/059094

§ 371 Date: Oct. 10, 2025

(30) Foreign Application Priority Data
Apr. 12, 2023 (DE) 10 2023 109 241.3

(51) Int. Cl. B60R 1/28; H04N 23/90

(52) U.S. Cl. CPC B60R 1/28; H04N 23/90; B60R 2300/105; B60R 2300/306; B60R 2300/802

(57) ABSTRACT

A method for representing surroundings of a vehicle on a display unit of the vehicle is provided in which the vehicle travels at a speed during a journey, wherein surroundings of the vehicle are recorded by a primary camera of the vehicle, the camera being oriented counter to a forward direction of travel of the vehicle, wherein an angle for capturing the surroundings is provided for the primary camera, wherein the angle is set inversely proportional to a power of the speed of the vehicle, and wherein the surroundings are represented on the display unit at the set angle.

### BACKGROUND

### Technical Field

The disclosure relates to a method for representing surroundings of a vehicle and a system for representing surroundings of a vehicle.

### Description of the Related Art

The publication EP3572284B1 describes a display device for the surroundings of a vehicle.

A method and a device for displaying images from a rear view camera system of a motor vehicle are known from publication DE102010020201B4.

Against this background, one task was to represent the surroundings behind a vehicle to a driver of the vehicle in a suitably image-stabilized manner.

The method according to the disclosure is provided for representing the surroundings of a vehicle, for example, a motor vehicle, on a display unit, or alternatively on a monitor, screen or display, of the vehicle. The vehicle travels at a speed during a journey, wherein a primary camera of the vehicle, which is being oriented or alternatively is oriented counter to a forward direction of travel of the vehicle, records surroundings of the vehicle, which are usually found behind the vehicle, and usually counter to the forward direction of travel. In so doing, an angle for capturing the surroundings is provided for the primary camera, wherein the angle or alternatively a value for the angle is set inversely proportional to at least one power of the speed or alternatively a value of the speed in km/h of the vehicle, and wherein the surroundings are represented or alternatively shown on the display unit at the angle set for the primary camera or alternatively within this angle.

It is possible that the angle w or alternatively the value of the angle w of the primary camera is set inversely proportional to at least an nth power of the speed v or alternatively the value of the speed v of the vehicle, wherein an exponent n is a natural number. In so doing, the angle w can be inversely proportional to the speed v and/or inversely proportional to twice, three times, and/or k times the power of the speed v. It is also conceivable that the angle w is inversely proportional to a polynomial of the nth degree of the speed: w~(a*v+b*v²+c*v³ + . . . +d*v^{k})⁻¹, wherein a, b, c and d are proportionality factors, wherein n=1, 2, 3, . . . k. In general, the angle becomes smaller as the speed v increases and larger as the speed v decreases.

Herewith, the angle of the primary camera opens up counter to the forward direction of travel. If, for example, the primary camera is arranged on the right outer side of the vehicle, its angle opens up counterclockwise from the direction counter to the forward direction of travel. If the primary camera is arranged on the left outer side of the vehicle, its angle opens up clockwise from the direction counter to the forward direction of travel. If it is arranged on a central longitudinal axis of the vehicle, its angle opens up symmetrically to the direction counter to the forward direction of travel.

In arrangement, the angle of the primary camera is set as a function of the speed of the vehicle. In so doing, an angle range of the angle of the primary camera, which is configured as an opening angle, is set inversely proportional to at least one power of the speed of the vehicle. In so doing, the angle range and/or the opening angle or, alternatively, within the angle range and/or the opening angle, a surrounding area of the surroundings or, alternatively, in the surroundings counter to the forward direction of travel of the vehicle, is covered and/or captured.

It is, moreover, also possible for the surroundings to be recorded by a secondary camera that is being or is oriented perpendicular to the forward direction of travel of the vehicle, either to the right or to the left, wherein an angle, for example, the opening angle and/or angle range, of the secondary camera being or alternatively is set independently of the speed of the vehicle, usually in a constant manner. In so doing, the primary camera on the right outer side can be combined with a secondary camera oriented to the right on the right outer side of the vehicle. Alternatively, or in a complementary manner, the primary camera on the left outer side can be combined with a secondary camera oriented to the left on the left outer side of the vehicle.

In so doing, the secondary camera records a blind spot of the vehicle next to the vehicle, wherein the blind spot or alternatively the surroundings in the blind spot next to the vehicle are represented by the display unit in addition to the surroundings recorded by the primary camera, which are usually found behind the vehicle. In so doing, the surrounding areas recorded by the two cameras are combined by the display unit. In so doing, the surroundings recorded by the secondary camera, for example, a lateral surrounding area of the surroundings next to the vehicle, can be superimposed on the surroundings recorded by the primary camera, for example, into a rear surrounding area of the surroundings behind the vehicle.

It is, moreover, possible that the speed of an object moving in the surroundings, for example, a further vehicle or alternatively an extraneous vehicle, which is recorded or alternatively captured by at least one of the cameras, which is to say, by the primary and/or secondary camera, is compared with the speed of one's own vehicle or alternatively of an own vehicle. In so doing, the object is additionally represented by the display unit on top of the surroundings recorded by the primary camera, for example, superimposed onto the surroundings recorded by the primary camera, this if the speed of the object is less than a definable fraction of, for example, 10%, 20%, 30%, or 40% of the speed of one's own vehicle, for example, at least 60%, 70%, 80%, or 90% of the speed of one's own vehicle, and/or if the speed of the object is at least as high as the speed of one's own vehicle.

### BRIEF SUMMARY

The system according to the disclosure is configured to represent the surroundings of a vehicle on a display unit, wherein the system comprises the display unit, a primary camera, and a processing unit as components, which are contemporaneously also components of the vehicle. In so doing, the vehicle travels at a speed during a journey. The primary camera being or alternatively is oriented counter to a forward direction of travel of the vehicle or alternatively is aligned and is configured to record surroundings of the vehicle counter to the forward direction of travel. In so doing, an angle, for example, an opening angle and/or angle range, being provided or alternatively is provided for the primary camera for detecting the surroundings. The processing unit is configured to set the angle inversely proportional to at least one power of the speed of the vehicle, wherein the display unit is configured to represent the surroundings at the angle set for the primary camera.

It is possible to implement an embodiment of the presented method with an embodiment of the presented system.

The display unit is, as a rule, configured or alternatively designated in combination with the primary camera, as a virtual and/or simulated rearview mirror and/or exterior mirror of the vehicle, which represents the surroundings behind the vehicle as in a mirror. The display unit is, moreover, arranged on a lateral outer wall and/or outer side of the vehicle in front of a first or alternatively front row of seats, for example, on a passenger side or a driver side of the vehicle, which is to say, in a usual position of the exterior mirror of the vehicle. The display unit for the virtual exterior mirror is arranged either on the passenger side or driver side of the vehicle on the outer wall, for example, the body, of the vehicle. Alternatively, the display unit is arranged in an interior of the vehicle, for example, in a display or instrument panel, or at a usual position of the rearview mirror, for example, on an upper edge of a windshield and/or at a transition of the windshield to a headliner in the vehicle, centrally, to the left of a steering wheel or to the right of the steering wheel.

The primary camera is configured to record the surroundings counter to the forward direction of travel and/or behind the vehicle. It is conceivable that the system may additionally comprise a secondary camera that is configured to record the surroundings to the side of the vehicle and/or perpendicular to the forward direction of travel. In so doing, the display unit is configured on the one hand to represent the surroundings recorded by the primary camera within the speed-dependent angle. On the other hand, the display unit is configured to superimpose the surroundings recorded by the secondary camera onto the surroundings recorded by the primary camera.

Using the method and the system, a control of the angle of the primary camera, for example, steering and/or regulation is possible, wherein an image of the surroundings can be represented on the display unit in a stable manner without blurring, wherein vibrations of such an image that would otherwise occur can be avoided. In so doing, the angle is set smaller the greater the speed of the vehicle is. The angle, for example, the opening angle and/or angle range, is directly inversely proportional to the power of the speed, wherein the angle is dependent on the speed, usually continuously, which is why a shifting between different representations of the surroundings can be dispensed with.

In addition to the speed-dependent and primary camera-recorded representation of a first surrounding area of the surroundings behind the vehicle, the display unit can also represent the lateral surrounding area, usually recorded by the secondary camera, and/or a traffic situation next to the vehicle, for example, the blind spot, independently of the respective speed on the display unit.

The image of the surroundings on the display unit, for example, for a right-hand virtual exterior mirror (VES) can be stabilized with the method and the system, as it is now possible to dispense with a rigidly predefined wide-angle image. In this manner, distractions and disturbances for the driver can be avoided. The image represented is stabilized and a representation of the blind spot is realized. When driving at higher speeds, a smaller angle can be set. When driving at lower speeds, a larger angle or alternatively a wide angle is set. Exceptions are provided for other road users as objects in the surroundings, which are found, for example, to the right or left of the vehicle, which have a similar speed to the vehicle, and which are relevant to the driver of the vehicle. Here, for example, algorithms are used, with which traffic situations relevant to the vehicle and/or the driver are detected by way of the sensors available in the vehicle, for example, the primary and/or secondary camera. Even at higher speeds, it is possible to represent the blind spot in, for example, the right display unit or alternatively the display.

It is understood that the features mentioned above and those to be explained below are not only usable in the combination respectively specified, but also in other combinations or individually, without leaving the scope of the present invention.

### BRIEF DESCRIPTION OF THE SEVERAL VIEWS OF THE DRAWINGS

Using embodiments, the disclosure is schematically illustrated in the drawings and is described schematically and in detail with reference to the drawings.

FIG. 1a, FIG. 1b, and FIG. 1c show a schematic representation of a vehicle that has an embodiment of the system according to the invention, during implementation, in different situations, of an embodiment of the method according to the invention.

FIG. 2a and FIG. 2b show the vehicle from FIG. 1a, FIG. 1b, and FIG. 1c in a schematic representation during implementation, in further situations, of the embodiment of the method according to the invention.

FIG. 3 shows details of an interior of the vehicle from FIG. 1a, FIG. 1b, FIG. 1c, FIG. 2a, and FIG. 2b and details of the embodiment of the system according to the disclosure in schematic representation.

The figures are described in a coherent and comprehensive manner. Identical reference symbols refer to the same components.

### DETAILED DESCRIPTION

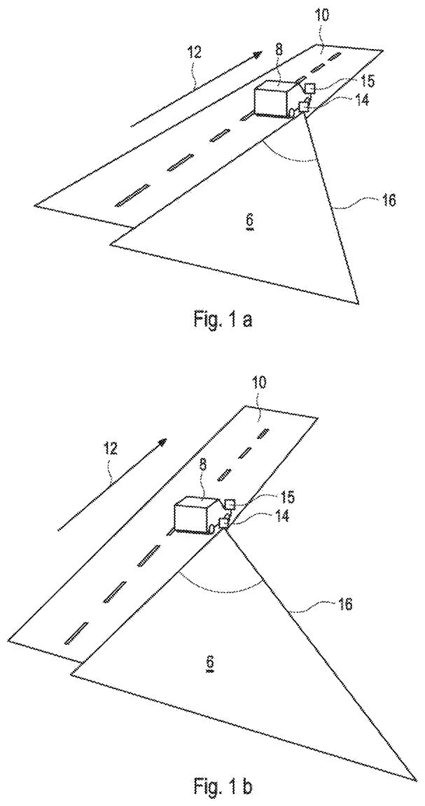

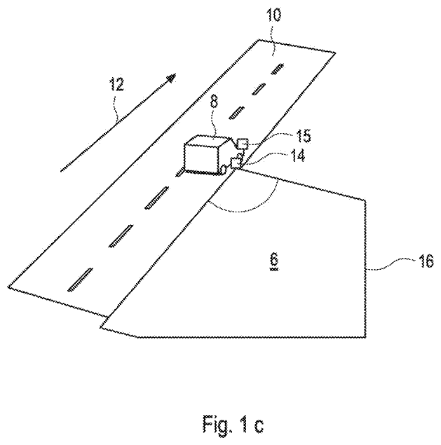

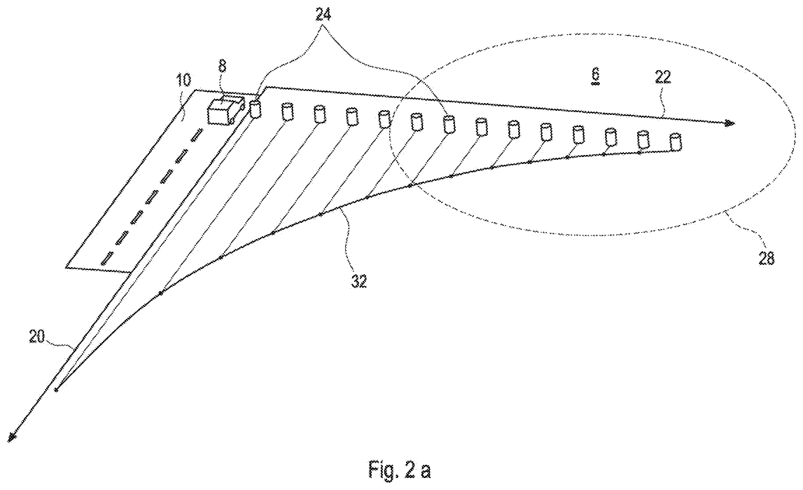

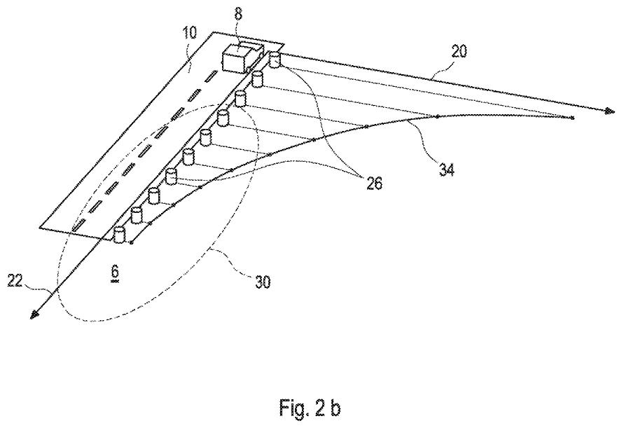

FIG. 1a, FIG. 1b, FIG. 1c, FIG. 2a, and FIG. 2b show schematic representations of the vehicle 8, which is configured here as a motor vehicle, which can be found on a roadway 10 in surroundings 6 or alternatively in an environment and traveling in a forward direction of travel 12 at a respective speed.

In the forward direction of travel 12, a primary camera 14 is arranged on a right-hand outer wall and/or outer side of the vehicle 8, here on a passenger side, which primary camera is aligned towards the surroundings 6 in the direction counter to the forward direction of travel 12, wherein, here in FIG. 1a, FIG. 1b, FIG. 1c, an angle 16 of this primary camera 14 is indicated, within which the surroundings 6 are recorded by the primary camera 14.

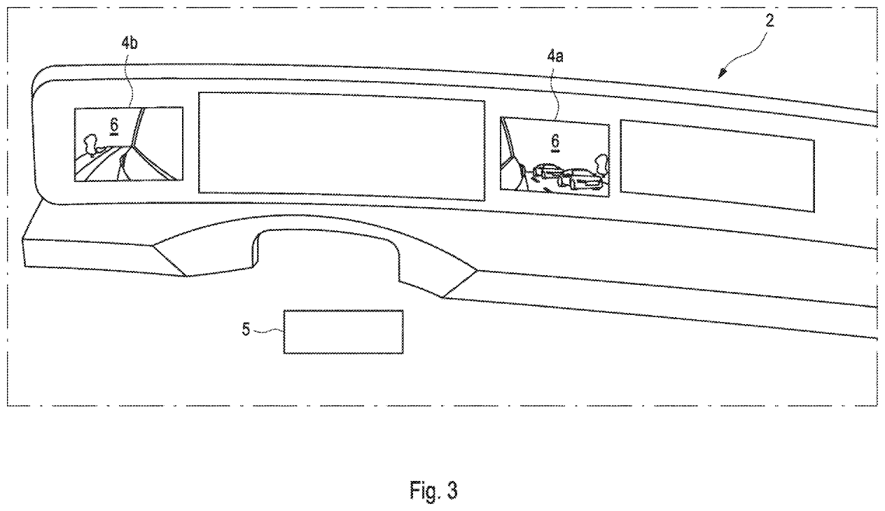

FIG. 3 shows one part of a cockpit 2, configured here as a single cockpit, in an interior of the vehicle 8, in which a first display unit 4a is arranged in front of a driver seat, here to the right of a steering wheel of the vehicle 8, which is not shown in further detail. A second display unit 4b is, moreover, arranged to the left of the steering wheel. The vehicle 8, moreover, has a processing unit 5. In one or more implementations, the processing unit includes a processor and a memory storing instructions that, when executed by the processor, cause the processing unit to perform the acts described herein. It is provided that the surroundings 6 recorded by the first primary camera 14 on the passenger side counter to the forward direction of travel 12 are represented with, by, and/or on the right-hand first display unit 4a. Correspondingly, a further or alternatively second primary camera may also be arranged on the driver side as the outer side of the vehicle 8 on the left, wherein the surroundings 6 recorded by the second primary camera at an angle counter to the forward direction of travel 12 on the driver side are represented with, by and/or on the left display unit 4b. Accordingly, the first primary camera 14 and the first display unit 4a or alternatively a display, which are assigned to each other, form and/or simulate a first virtual exterior mirror (VES) on the passenger side. The second primary camera and the second display unit 4b or alternatively a display, which are assigned to each other, form and/or simulate a second virtual exterior mirror (VES) on the driver side.

It is provided that at least one primary camera 14, its associated display unit 4a, 4b, and the processing unit 5 are configured as components of the embodiment of the system according to the disclosure for implementing the embodiment of the method according to the invention.

In the method, the angle 16 of the primary camera 14 is set inversely proportional to a power of the current speed or alternatively proportional to a reciprocal value of the speed of the vehicle 8. The surroundings 6 are, moreover, represented on the display unit 4a, 4b at the angle 16 set for the primary camera 14. A respective angle 16, the value of which is usually, for example, in degrees, is calculated by the processing unit 5 depending on the respective speed of the vehicle 8. In so doing, the angle 16 or alternatively an angle range which is covered by the angle 16 extends from a longitudinal axis oriented parallel to the forward direction of travel 12 on a respective outer side or alternatively outer wall of the vehicle 8 from the surroundings 6 behind the vehicle 8 into a surrounding area, counterclockwise (if the primary camera is arranged on the left side of the vehicle) or clockwise (if the primary camera is arranged on the right side of the vehicle), to the side of the vehicle 8.

In the first situation in FIG. 1a, vehicle 8 has an initial high speed v, which in this case is greater than 50 km/h (v>50 km/h). In a second situation in FIG. 1b, vehicle 8 has a second average speed v, which in this case is between 20 km/h and 50 km/h (20 km/h≤v≤50 km/h). In a third situation in FIG. 1c, vehicle 8 has a third low speed v, which in this case is less than 20 km/h (0 km/h ≤v<20 km/h), wherein it is also possible that vehicle 8 is stationary.

The system can optionally also have at least one secondary camera 15, here a first secondary camera 15 on the passenger side right, and a second secondary camera not shown on the driver side left. In so doing, the first secondary camera 15 is aligned or alternatively oriented laterally to the right, perpendicular to the forward direction of travel 12. The second secondary camera is aligned or alternatively oriented laterally to the left, perpendicular to the forward direction of travel 12.

In the first situation (FIG. 1a), the angle 16 of the primary camera 14 is reduced when the vehicle 8 is traveling at high speed, wherein it is, for example, 30°and extends or alternatively expands 30° to the right or alternatively counterclockwise from the longitudinal axis. In the first situation, the first display unit 4a shows the driver of the vehicle 8 only a small surrounding area of the surroundings 6 behind and next to the vehicle 8, on which first display unit the driver can concentrate at the high speed.

In the second situation (FIG. 1b), the angle 16, here by way of example, is increased to 50° and/or extended laterally to the right or alternatively counterclockwise when the vehicle 8 is traveling at medium speed. Compared to the first situation, the first display unit 4a shows a larger surrounding area of the surroundings 6 to the right of the vehicle 8 without the image of the surroundings 6 becoming too unstable, wherein the driver is better able to capture the lateral surrounding area under the enlarged angle 16.

In the third situation (FIG. 1c), the angle 16 is increased from the second situation, here by way of example, to 90° and/or wound up sideways to the right or alternatively counterclockwise if the vehicle 8 is traveling at the low or alternatively slow speed or is stationary at a speed of 0 km/h. In so doing, the display unit 4a represents the rear surrounding area and the entire or complete lateral surrounding area of the surroundings 6 to the right of the vehicle 8, which also includes a blind spot next to the side of the vehicle 8. The driver can see the surroundings 6 under the correspondingly enlarged angle 16, including the blind spot, without the image of the surroundings 6 becoming too unstable.

In the method, it is optionally possible that, on, by and/or with the display device 4a, in addition to the surrounding area of the surroundings 6 which is recorded by the primary camera 14 as a function of the speed in the direction counter to the forward direction of travel 12 at an angle 16, the surrounding area of the surroundings 6 recorded by the secondary camera 15 is also represented to the side of the vehicle 8 and, for example, additionally superimposed. This is, for example, possible if the current speed or alternatively a value for this speed is greater than a limit value definable for this purpose, and if a correspondingly set angle 16 or alternatively its value is less than a resulting corresponding limit value.

This is, for example, possible in the first situation if the entire display unit 4a or alternatively the display is not filled out by the surroundings 6 which are recorded by the primary camera 14. A remaining or alternatively gained space on the display unit 4a can be used for the surrounding area of the surroundings 6 next to the vehicle 8, as recorded by the secondary camera 15. In so doing, by way of example, an object 24, 26 (FIG. 2a, FIG. 2b) next to the vehicle 8 can be superimposed. The object 24, 26, which is found, for example, in the blind spot next to the vehicle 8, is then superimposed, for example, when its speed compared to the vehicle 8 is less than the speed of the vehicle 8 by a definable fraction and/or is at least as great as the speed of the vehicle 8. It is also possible to use the remaining space to represent a zoomed in perspective or alternatively an enlargement of the surroundings 6 or to represent a change in position.

In so doing, the object 24, 26 is additionally represented by the display unit 4a in addition to the surroundings 6 recorded by the primary camera 14, for example, superimposed on the surroundings 6 recorded by the primary camera 14, if the speed of the object 24, 26 is less than the speed of one's own vehicle 8 by a definable fraction and, for example, 60%, 70%, 80% or 90% of the speed of one's own vehicle 8, and/or when the speed of the object 24, 26 is at least as great as the speed of one's own vehicle 8.

FIG. 2a additionally shows a speed axis 20, which is oriented here counter to the forward direction of travel 12, and a distance axis 22, which is oriented here perpendicular to the speed axis 20. FIG. 2a moreover shows objects 24, which are arranged in the surroundings 6 laterally adjacent to the vehicle 8 perpendicular to the forward direction of travel 12.

FIG. 2b additionally shows the distance axis 22, which is oriented in the direction counter to the forward direction of travel 12, and the speed axis 20, which is oriented perpendicular to the distance axis 22 in the direction of travel. FIG. 2b moreover shows objects 26, which are arranged in the surroundings 6 laterally adjacent to a distance already traveled by the vehicle 8 parallel to the forward direction of travel 12.

In so doing, in a diagram shown in FIG. 2a, which is spanned by the speed axis 20 and the distance axis 22, a first curve 32 is represented that illustrates a physical relationship between the speed and a stability of the image on the display unit 4a for the objects 24 that are found perpendicular to the forward direction of travel 12 to the side of the vehicle 8, among other things, in a first surrounding area 28 in the surroundings 6 next to the vehicle 8.

Furthermore, in a diagram shown in FIG. 2b, which is spanned by the speed axis 20 and the distance axis 22, a second curve 34 is moreover represented that illustrates a physical relationship between the speed and stability of the image on the display unit 4a for the objects 26 that are found parallel to the forward direction of travel 12 to the side of the vehicle 8, among other things, in a second surrounding area 30 in the surroundings 6 behind the vehicle 8.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for representing surroundings of a vehicle on a display unit of the vehicle, in which the vehicle travels at a speed during a journey, the method comprising:
recording the surroundings of the vehicle by a primary camera of the vehicle, the primary camera being oriented counter to a forward direction of travel of the vehicle;
providing an angle for capturing the surroundings for the primary camera, wherein the angle of the primary camera is set inversely proportional to a power of the speed of the vehicle; and
representing the surroundings on the display unit at the angle of the primary camera set inversely proportional to the power of the speed of the vehicle.

2. The method according to claim 1, wherein the angle of the primary camera is set inversely proportional to a single power of the speed of the vehicle.

3. The method according to claim 1, wherein the angle of the primary camera opens up in the direction counter to the forward direction of travel.

4. The method according to claim 1, further comprising:
recording the surroundings by a secondary camera that is oriented perpendicular to the forward direction of travel of the vehicle.

5. The method according to claim 4, wherein the secondary camera records a blind spot next to the vehicle and the blind spot is represented by the display unit.

6. The method according to claim 4, further comprising:
comparing a speed of an object moving in the surroundings and captured by at least one of the primary camera or the secondary camera with the speed of the vehicle, wherein the object is represented by the display unit if the speed of the object is slower than the speed of the vehicle and/or if the speed of the object is at least as fast as the speed of the vehicle.

7. A system for representing surroundings of a vehicle, the system comprising:
a display unit;
a primary camera; and
a processing unit,
wherein the vehicle travels at a speed during a journey, wherein the primary camera is oriented counter to a forward direction of travel of the vehicle,
wherein the primary camera, in operation, records the surroundings of the vehicle,
wherein processing unit, in operation, provides an angle for the primary camera for detecting the surroundings,
wherein the processing unit, in operation, sets the angle inversely proportional to a power of the speed of the vehicle, and
wherein the display unit, in operation, represents the surroundings at the angle of the primary camera set inversely proportional to the power of the speed of the vehicle.

8. The system according to claim 7, wherein the display unit is configured as a virtual rearview mirror and/or exterior mirror of the vehicle.

9. The system according to claim 7, wherein the display unit is arranged on an outer wall of the vehicle or in an interior of the vehicle.
